(19) United States
(12) Patent Application Publication
(10) Pub. No.: US 2012/0312341 A1
(43) Pub. Date: Dec. 13, 2012

(54) APPARATUS FOR MONITORING THE ROTATION OF THE SPRAYING ARMS OF A MULTI-RACK TROLLEY OF A CLEANING MACHINE

(76) Inventors: Roman Rieder, Zizers (CH); Philipp Küttel, Stansstad (CH)

(21) Appl. No.: 13/295,207

(22) Filed: Nov. 14, 2011

(30) Foreign Application Priority Data
Nov. 16, 2010 (DE) 102010051524.8

(51) Int. Cl. B08B 3/00

(52) U.S. Cl. 134/198

(57) ABSTRACT

Apparatus for monitoring the rotation of the spraying arms of a trolley (10) for holding objects to be cleaned. The trolley may be introduced into the spraying compartment (40) of a cleaning machine for utensils arranged on the individual tiered levels (11) of the trolley (10). The rotational axis (B) of the spraying arms of the trolley (10) in the spraying compartment (40) are offset from the center plane (A) of the spraying compartment (40). On side walls of the spraying compartment (40), sensor tubes (51) are arranged, in which a number of magnetic detectors (53, 54) assigned to a possible rotational plane of a spraying arm (3) are arranged. This detection range encompasses the rotational plane of an individual spraying arm (3) and the area immediately above and immediately below it. Magnets (52) are arranged at the ends of the spraying arms (3) to actuate the magnetic detectors (53, 54).

The invention pertains to a rotation-monitoring apparatus for a multi-rack trolley for holding objects to be cleaned, which trolley can be introduced into the spraying compartment of a cleaning machine for cleaning medical, pharmaceutical, and/or laboratory utensils, which are to be arranged on the individual tiered racks of the trolley.

Trolleys for holding objects to be cleaned, which can be introduced into the spraying compartment of cleaning machines like dishwashers or machines for cleaning medical, pharmaceutical, and/or laboratory utensils, are known, wherein the term “cleaning” is intended to include the treatment of the individual utensils or objects with a washing liquid, a spraying liquid, and possibly drying air. These trolleys which hold the objects to be cleaned usually comprise several racks or levels arranged one above the other, in which the objects to be cleaned can be placed, either in baskets or directly on the racks or levels, wherein each of these levels is assigned at least one spraying arm, which can rotate around a vertical rotational axis, which simultaneously serves to supply a fluid medium such as washing liquid or drying air by way of channels, which, when the trolley holding the objects to be cleaned is introduced into the spraying compartment, become connected to a supply and distribution device arranged in the spraying compartment.

By aiming the jets of fluid medium emerging from the spraying arms in the appropriate direction, the spraying arms can be driven around their rotational axis.

If the objects to be cleaned have not been arranged correctly on the individual levels, however, they can interfere with the rotation of the individual spraying arms, as a result of which the cleaning action is significantly impaired.

For this reason, it is standard practice to provide devices to monitor the rotation of the spraying arms, so that the machine can be stopped if one or more of the spraying arms is not rotating.

These monitoring devices are relatively complicated in some cases and are not suitable for all applications.

The invention is based on the goal of creating an apparatus for monitoring the rotation of the spraying arms of a trolley for holding objects to be cleaned of the type indicated above, namely, a monitoring apparatus which, even though simple in design, can be used universally for trolleys of all different types.

This goal is achieved by the features given in claim 1.

Advantageous embodiments and elaborations of the invention can be derived from the subclaims.

In the inventive rotation-monitoring apparatus, sensor tubes are arranged on the two side walls of the spraying compartment; even in the case of a trolley in which the rotational axes of the spraying arms are offset from a plane which is in the center when looked at in the direction in which the trolley is pushed into place, these sensors make it possible to monitor the rotation of the spraying arms reliably. Depending on the side toward which the rotational axes are offset from the previously mentioned central plane, the detectors of the sensor tubes closest to the associated ends of the spraying arms are actuated, this making it possible in turn to detect the orientation of the trolley and also its type as well as to determine whether or not the spraying arms are rotating properly.

The sensor tubes preferably contain magnetic detectors in the form of, for example, reed switches, wherein a magnet, which actuates the magnetic detectors in the sensor tubes when the magnet passes by them, is arranged on at least one of the free ends of a spraying arm.

According to a preferred embodiment of the invention, the magnets mounted on the ends of the spraying arms are designed in such a way that the only magnetic detectors which are actuated are those which, because of the offset between the rotational axes of the spraying arms and the center plane of the spraying compartment, are closest to the ends of the spraying arms.

It is advantageous for the magnets to be arranged laterally next to the ends of the spraying arms, so that additional nozzles can be installed at the ends of the spraying arms; these nozzles are preferably formed in the end caps, which are mounted on the spraying arms to seal off the free ends of the arms. These end caps can preferably be used simultaneously as holders for the laterally arranged magnets.

According to another advantageous embodiment of the invention, two magnetic detectors installed in sensor tubes arranged vertically one above the other are assigned to each of any possible height at which an individual spraying arm can be positioned. These detectors thus make it possible to increase the monitoring range in the vertical direction and thus provide reliable monitoring even when the heights of the individual spraying arms vary as a result of manufacturing tolerances.

The invention is explained in greater detail below on the basis of the exemplary embodiments shown in he drawings:

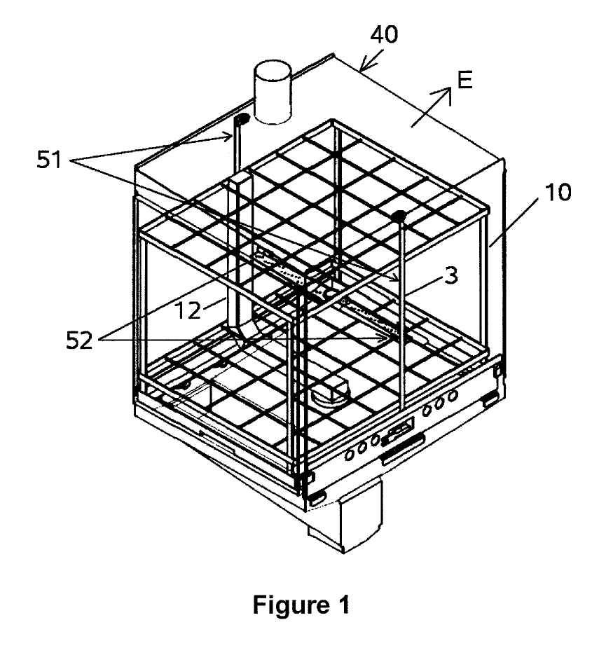

FIG. 1 shows a perspective schematic diagram of a spraying compartment, into which a trolley has been pushed;

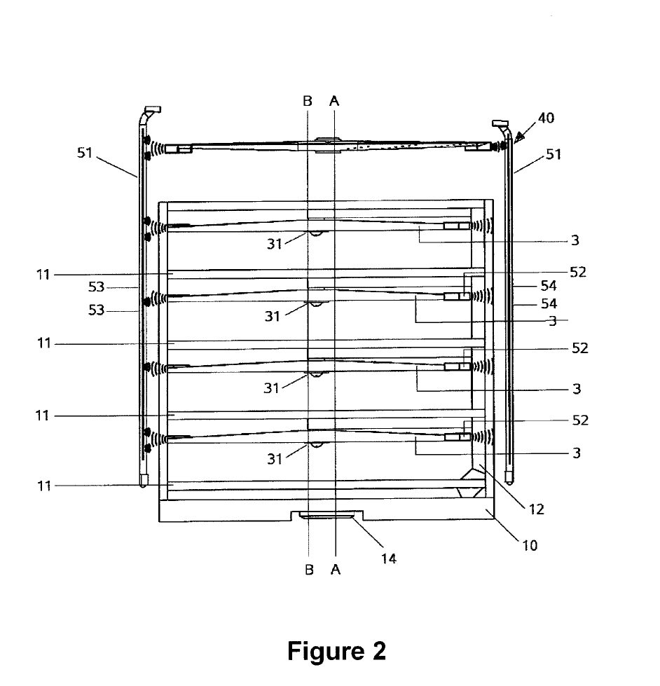

FIG. 2 shows a simplified front view of the spraying compartment and of the trolley according to FIG. 1;

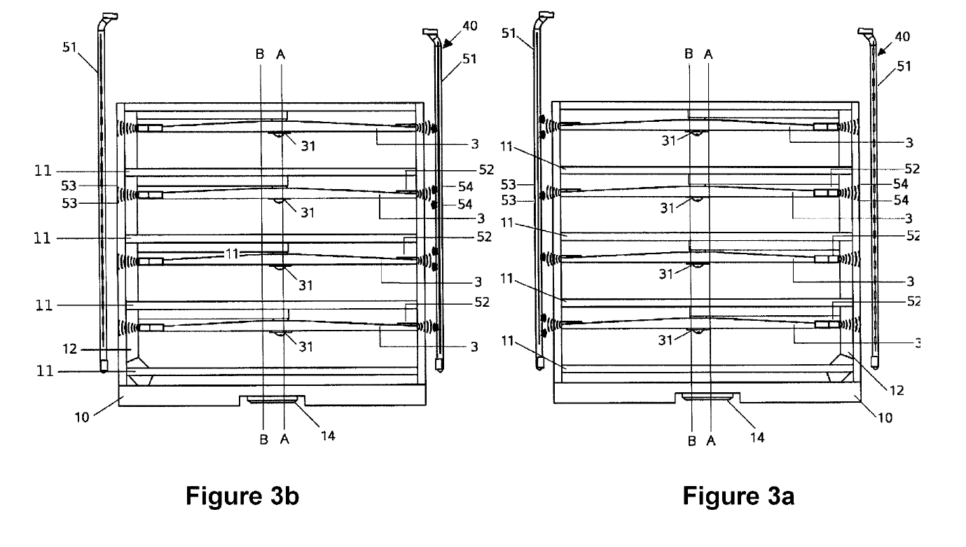

FIGS. 3a and 3b show simplified diagrams of the position of the trolley with respect to the sensor tubes mounted on the side walls of the spraying compartment, the trolley being in two different positions rotated 360° from each other around the vertical axis; and

FIG. 3 shows a view of one end of a spraying arm.

FIG. 1 shows a schematic diagram of part of a cleaning machine for cleaning medical, pharmaceutical, and/or laboratory utensils, which comprises a spraying compartment 40, in which a trolley 10 for holding medical, pharmaceutical, and/or laboratory utensils 1 can be pushed in direction E according to FIG. 1, wherein these utensils are to be arranged on the levels or racks 11 of the trolley 10 shown in FIG. 2 or in baskets fixed to or resting on those shelves or racks.

Each level or rack 11 of the trolley 10 is assigned at least one spraying arm 3, which is supplied with washing liquid, rinsing liquid, and/or drying air through individual rotary couplings 31 with feed channels 12. These fluid media are supplied through a vertical channel 12, arranged on one side of the trolley 10, this channel being connected to the spraying compartment 40 of the machine by a coupling device 14.

Because of the arrangement of this vertical channel 12 on one side of the trolley 10, the rotational axes of the spraying arms 3 are oriented along a vertical line B which, as shown in FIGS. 2, 3a, and 3b, is offset from the center plane A both of the trolley 10 and of the spraying compartment 40.

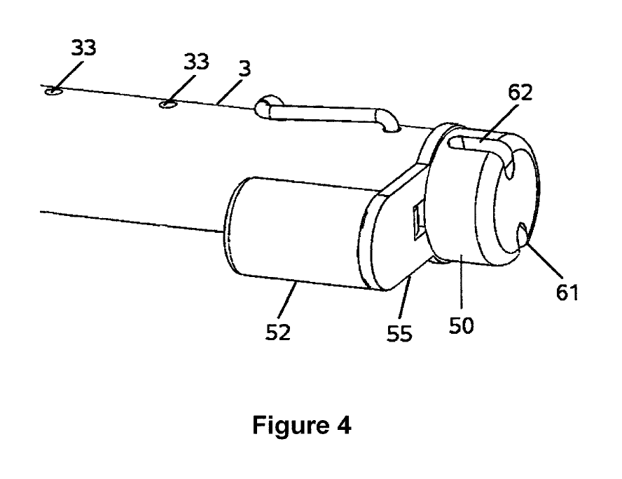

So that the trolley 10 can be pushed into the spraying compartment 40 in two different positions rotated 180° apart around a vertical axis, the first of which is shown in FIGS. 2 and 3b, the second position being shown only in FIG. 3a, sensor tubes 51 are mounted on both side walls of the spraying compartment 40, these sensor tubes cooperating with magnets 52 provided on the ends of the spraying arms 3 as shown in FIG. 4.

So that, furthermore, the rotation of the spraying arms 3 can be detected at different heights, depending on the trolley, these sensor tubes 51 preferably contain two magnetic detectors 53, 54 at every possible position of a spraying arm, these detectors thus being able to sense the area both underneath and above the rotational planes of all possible spraying arms.

The strength of the magnets 52 of an individual spraying arms 3 and the sensitivity of the individual magnetic detectors 53 are selected so that, in the case of the arrangement shown in FIGS. 2, 3a, and 3b, only the magnetic detectors which are actuated are those which, as a result of the offset between line B of the rotational axes and the center plane A of the spraying compartment, are closest to the ends of the spraying arms 3.

This means that, in the position of the trolley according to FIGS. 2 and 3b, the detectors which are actuated are detectors 53, which are arranged in the detector tube 51. The detectors 54 in the detector tube 51 on the right according to FIG. 2 are farther away from the ends of the spraying arms 3 and thus are not actuated by them.

In a corresponding manner, only the magnetic detectors 54 are actuated in the case of the alignment of the trolley shown in FIG. 3a, because these are the detectors which are now closest to the ends of the spraying arms.

In this way it is possible not only to monitor the satisfactory rotation of the spraying arms but also to determine the height of the spraying arms 3 present in a certain trolley 10 and also to determine the orientation of the trolley 10 when it is pushed into the spraying compartment 40. This means that the trolley 10 can be pushed into the spraying compartment 40 freely in either of its two possible positions, which are 180° apart.

The individual sensors 53, 54 are preferably oriented as reed switches, which are actuated whenever one of the magnets 52 at the end of a spraying arm 2 passes by them.

To ensure that the magnetic detectors transmit signals reliably even in the presence of variations in the rotational planes of the spraying arms 3 attributable to manufacturing tolerances, two magnetic detectors 53, 54 are preferably assigned to every possible height, one of them above the rotational plane, the other below it, which thus increases the detection range.

As a result of the arrangement, shown in FIG. 5, of the magnets 52 on a holder 55 in a position laterally offset from the longitudinal axis of the spraying arms 3, these spraying arms can be provided with end caps 60, which allow the installation of outlet nozzles 61, 62 for creating additional jets of the fluid medium without the danger that these jets will be obstructed by the magnets.

In cases where the upper and lower spraying arms in the spraying compartment are rotatably mounted in the spraying compartment 40 itself, the sensor tubes 51 can be lengthened correspondingly upward and/or downward and can be provided with corresponding additional magnetic detectors, so that the rotation of these spraying arms can also be monitored.

If, conversely, a one-piece spraying arm (not shown) with a vertical support post to which a number of spray half-arms are rigidly attached is used in place of separately rotatable spraying arms assigned to each level or rack 11 of the trolley 10, it can be sufficient to monitor the rotation of only one of the spray half-arms.

1. An apparatus for monitoring the rotation of the spraying arms of a trolley for holding objects to be cleaned, which trolley can be introduced into the spraying compartment of a cleaning machine for cleaning medical, pharmaceutical, and/or laboratory utensils, which are to be arranged on the individual tiered levels of the trolley, to which individual spraying arms are assigned, which are able to rotate around a vertical rotational axis (B) and which are supplied with washing liquid through a rotary coupling, wherein the spraying arms are provided with outlet openings, from which jets of washing liquid can be directed onto the objects located on the individual levels of the trolley, wherein
the rotational axes (B) of the spraying arms of the trolley which has been pushed into the spraying compartment are offset from the center plane (A) of the spraying compartment extending in the direction in which the trolley is pushed in; in that
on both of the side walls of the spraying compartment, sensor tubes are arranged, in which a number of magnetic detectors assigned to a possible rotational plane of a spraying arm are arranged, the detection range of which encompasses the rotational plane of an individual spraying arm and the area immediately above and immediately below it; and in that
magnets are arranged at the ends of the spraying arms to actuate the magnetic detectors when the ends of the spraying arms pass by them.

2. A rotation-monitoring apparatus according to claim 1, wherein the magnets mounted on the ends of the spraying arms are designed in such a way that only the magnetic detectors which are closest because of the offset between the rotational axes (B) of the spraying arms and the center plane (A) of the spraying compartment are actuated.

3. A rotation-monitoring apparatus according to claim 1, wherein he magnets are arranged laterally next to the ends of the spraying arms.

4. A rotation-monitoring apparatus according to claim 3, wherein the magnets are mounted on arms which are held in place on the spraying arms by end caps, which seal off the free ends of the spraying arms.

5. A rotation-monitoring apparatus according to claim 1, wherein the individual magnetic detectors are reed switches (53, 54).

6. A rotation-monitoring apparatus according to claim 5, wherein the individual reed switches are arranged vertically one above the other in the vertical sensor tubes.
